(19) United States
(12) Patent Application Publication
(10) Pub. No.: US 2002/0025085 A1
(43) Pub. Date: Feb. 28, 2002

(54) Computer-controlled system and method for generating a customized imprinted item

(75) Inventors: Mark Gustafson, Spokane, WA (US); Theodore Reischling, Seattle, WA (US); Samuel J. Comstock, Seattle, WA (US)

Correspondence Address: Darren E. Donnelly, Esq., McCutchen, Doyle, Brown & Enersen, LLP, Three Embarcadero Center, 28th Floor, San Francisco, CA, 94111, US

(73) Assignee: Ipads.Com, Inc.

(21) Appl. No.: 09/818,704

(22) Filed: Mar. 27, 2001

Related U.S. Application Data
(63) Continuation-in-part of application No. 09/552,293, filed on Apr. 19, 2000.

(51) Int. Cl. G06K 9/03

(52) U.S. Cl. 382/311

(57) ABSTRACT

A computer-implemented method and system for generating imprinted items customized by a user via the Internet or other interactive network. The method and system provides for receiving a specification of an item type, wherein associated with that item type are a plurality of constituent parts, including an image, which may be manipulated and edited. The method and system further provide for merging the item type data and constituent parts data to form a merged data set in a format suitable for a fabrication system. The fabrication system then incorporates the merged data with the selected item type to produce a finished product—an imprinted item customized by the user. The product is then provided to the user. Multiple products can be provided to multiple destinations.

### CROSS-REFERENCE TO RELATED APPLICATION

This application is a continuation-in-part of, and claims the benefit of priority to, co-pending U.S. patent application Ser. No. 09/552,293 filed Apr. 19, 2000, entitled “Client-Server Image Editing System”, by inventors Gustafson et al., which is herein incorporated by reference in its entirety.

### FIELD

Features of the invention relate to a computer-controlled method and system for generating imprinted items customized by a user via the Internet or other interactive network.

### BACKGROUND

Recently, there has been an upward trend in the popularity of digital cameras. The current generation of technology has seen wide acceptance and it is generally believed that digital camera technology will continue to progress rapidly, driving even wider acceptance and use.

Preceding this trend has been a similar growth in computing applications implemented via the world wide web (“web”). The open, public, nature of the Internet has made many web applications burgeon in consumer acceptance and prompted rapid generation of new features.

One opportunity to bring together aspects of digital camera use with web applications is the ability for digital camera users to take advantage of remotely-hosted services via a web application. One service which is desirable is custom printing applications. Thus there is a need for a means that allows digital camera users to create printed items customized with images they are free to provide via the web from virtually any location. Still further, there is a need to provide users the ability to edit their images with a web browser and customize the items they desire to have imprinted with their images.

Many web applications can grow rapidly in use and popularity given the ubiquity of the Internet. Thus, it would be desirable for any web-based custom printing system to be highly automated so that it can scale effectively. Still further, it would be desirable for such a system to be flexible and extensible and provide a framework for users to produce various types of items they desire to be customized with an image. There is the additional need for any such system to make efficient use of resources used for fabricating printed items so that cost advantages can be realized.

Related conventional systems have deficiencies that commonly arise from limited customization abilities. One conventional system is described in U.S. Pat. No. 4,873,643 which includes a system with design rules that restrict the placement and size of print elements. Such restrictions impair users' ability to express their preferences. It would be desirable if there were an improved system having an architecture allowing increased flexibility and customization.

Yet another drawback with conventional systems is that they are not accessible to remote users. Users of such conventional systems must travel to locations where such systems are located to operate the systems locally. With the rise in popularity of portable digital cameras, there is a need for the image application and image-related services to be as portable as the camera. It would be desirable if a user could access image-related services through open, public networks such as the Internet. It would be desirable to have a system which would allow a user to order customized imprinted items from any location providing network access, for instance from the convenience of the user's home.

Thus there is a need for a method and system that can easily and efficiently generate high quality customized imprinted objects in an efficient manner, from any convenient location with access to an open public network. Applicants have invented a user-friendly system which is capable of easily and efficiently producing an item imprinted with a customized image which operates over an open public network, thus allowing a user to order a customized imprinted item from any convenient location with access to an open public network.

### SUMMARY

These and other problems are beneficially solved by the present invention that provides a computer-controlled system and method of generating a customized imprinted item.

One aspect of the invention are computer-controlled methods for generating an imprinted item customized by a user. An illustrative method includes receiving a type of item desired by the user. The item is made up of several constituent parts, one of which is an image specified by the user. Based on a generic characterization of the type of item and customizing information provided by the user, a customized item characterization is generated. This customized item characterization can be provided to an appropriate device to create the actual, physical, customized imprinted item. For instance, the appropriate device could be a digital printer. In some versions, the item-customizing information is provided via client-server communications across a public computer network. Another aspect is that the user can be provided with a menu of many selectable item types. The particular constituent components can vary based on the particular type of item and be determined based on the item type selected by the user. Each of the constituent components may have attributes associated with them that can further be customized by the user. Yet another convenient customizing aspect is the ability to carry on remote image editing operations through client-server communications across the network. When placing orders for customized desired items, users can specify several orders during one session; arbitrary quantities of each of the items in the order can be sent to any of a number of desired destinations. Yet another feature is the combining of several ordered items during fabrication to make more efficient use of fabricating systems such as digital printers. In yet another feature, each item type can have a predetermined generic characterization separate from the customizing information. The item characterization can be self-defining to facilitate flexibility and extensibility.

Yet another aspect of the invention are computer-controlled systems for generating an imprinted item customized by a user. An illustrative system includes a public network and a server system. The server system is connected to the network and receives information for customizing a desired item from a remote user. The item-customizing information includes image data and the website server system allows the remote user to edit the image including cropping the image. The server system can employ a world wide web server application. A database operates with the server system for storing the item-customizing information as well as information for managing production, fulfillment, and resource planning functions. An additional element of this illustrative system is a software application which generates a characterization of the customized desired item based on a generic characterization of the desired item and the item-customizing information. This illustrative system also includes an item fabrication system for creating the customized desired item. In some instances the item fabrication system includes a digital printer. Characterizations of several customized desired items, each customized by a distinct user, can be combined for fabrication and concurrently fabricated.

### BRIEF DESCRIPTION OF THE DRAWINGS

The above features and others are obtained and may be understood with reference to the following detailed description and figures of illustrative embodiments where:

FIG. 1 depicts a system architecture flow diagram for generating a customized imprinted item;

FIG. 2 illustrates elements in an operating environment;

FIG. 3 illustrates a processing architecture for an image editing system;

FIG. 4 illustrates a data flow diagram of an image editing system;

FIG. 5 illustrates a user view of a parent screen for image editing operations;

FIG. 5-1 illustrates a process flow diagram for an image editing operation;

FIG. 5-2 illustrates a user view of an image editing operation;

FIG. 6 illustrates a process flow diagram of the crop image editing operation;

FIG. 6-1 illustrates a user view of a crop image editing operation interface;

FIG. 7 illustrates superimposition of image representations to establish a visibly distinct positionable selection area;

FIG. 8 depicts item components and attributes for user customization;

FIG. 9 depicts a user interface for the provision of item-customizing information;

FIG. 9-1 depicts a user interface for a customizing application;

FIG. 10-1 depicts a user interface allowing a user to select shipping to a single address or to multiple addresses;

FIG. 10-2 depicts a user interface illustrating product descriptions, quantities, and destinations, and

FIG. 10-3 depicts a user interface allowing the user to choose a method of shipping.

FIG. 11 depicts an operational process flow in connection with an illustrative embodiment.

### DETAILED DESCRIPTION

To aid in understanding, an illustrative overview of aspects more fully described below will be provided. Initially, a web browser under control of a remote user initiates a session with a server system. The server system provides the web browser with pages for the user to select a type of item desired by the user, e.g., a 50 sheet notepad. Upon the user indicating their type of desired item, the server system determines the particular constituent components for items of that type. In the case of the 50 sheet notepad, these could be, for instance, a background image, a foreground image, and caption text. The constituent components may have attributes with values; by specifying values for these the user can customize the item to their personal preferences. For instance, a font face for the caption text, a size and location of the foreground image, the particular choice of images, etc. can all be customized. The server system provides pages to the web browser of the user to gather item-customizing information for the constituent components and attribute values.

As part of this process, the user specifies an image for the desired item. This may be done, for instance by the user uploading an image or selecting an image already available to the server system. The user is not limited to specifying just one image; the user may specify a plurality of images for the desired item. In such case, and using the example of the 50 sheet notepad for illustrative purposes, the user could specify a different foreground image as well as a different background image and caption text for each sheet. A further aspect in this regard, is the ability of the user to perform image editing operations. Alternatively, the user could specify no foreground image at all, in which case the selected item would only have a background image.

During his or her session, the user may place orders for a number of desired items and specify shipping in arbitrary quantities to a plurality of shipping destinations for items in the order. The item-customizing information (as well as shipping and other information for completing the user's order) is stored until the transaction is completed, whereupon it is transferred to persistent storage.

Next, a customizing application generates a characterization of the customized desired item from a generic item characterization for the chosen item type and the item-customizing information from the user. A pre-processing application may translate or transform data taken as input by the customizing application. Similarly, a post-processing application may translate or transform data output by the customizing application. A fabrication system then receives the characterization of the customized desired item (possibly post-processed) and fabricates the customized desired item. Continuing the example above of the notepad, a digital printer prints the sheets of the notepad which are then assembled into the notepad. The completed customized desired item(s) are shipped through conventional fulfillment infrastructure in the user-specified quantities to the user-specified destinations.

Of course, as one skilled in the field will appreciate, the overview above is illustrative of embodiments of the invention and not limiting of the invention which is defined by the claims.

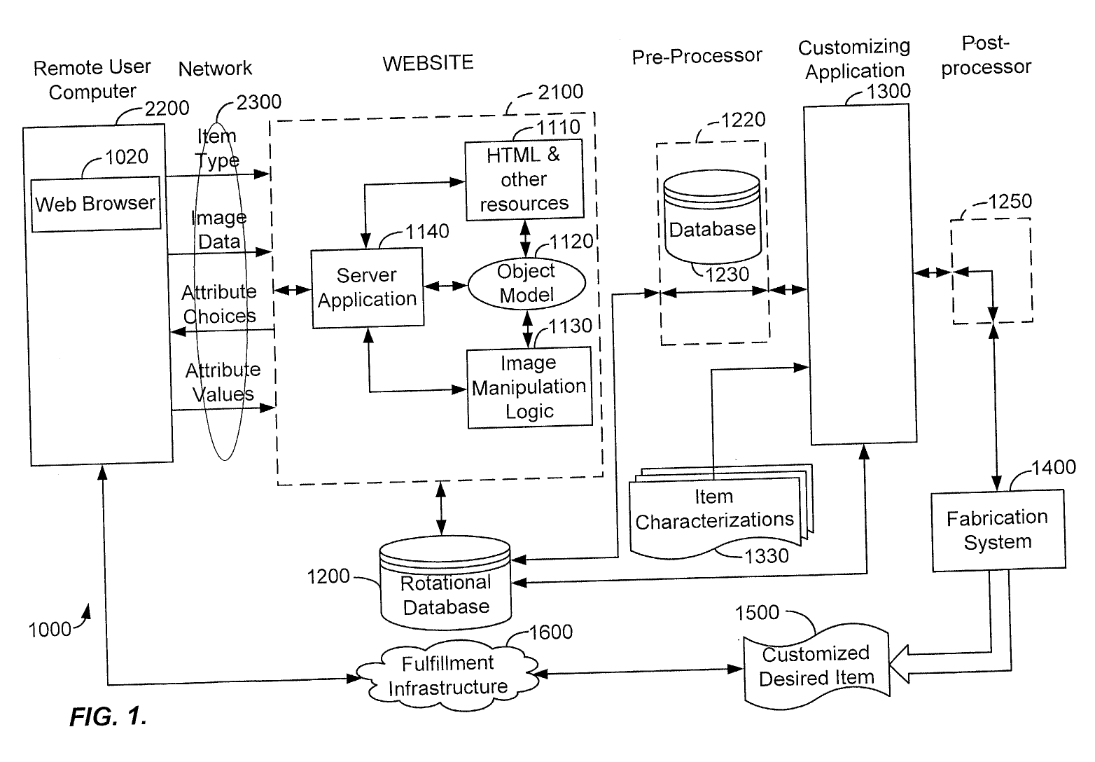

FIG. 1 illustrates in flow diagram form a system architecture 1000 of an illustrative embodiment of the invention. A remote user accesses a website server system 2100 across a data network 2300 for carrying on information exchange in connection with creating a customized desired item 1500.

The remote user employs a client computer system 2200 including a client application executing on computing machinery. In some embodiments, the client computer system 2200 includes a conventional web browser 1020, i.e., an HTTP client, executing on a general purpose computer. In other embodiments, different hardware or software platforms could be used, e.g., a set-top box or other limited-purpose hardware, a handheld or other mobile device. Further, it is contemplated that a client system could be an apparatus comprising digital photographic equipment and an integrated client application. The particular client application is not fundamental, except in that the client application and a server application 1140 should be compatible and able to perform functions in accordance with the invention.

In an illustrative embodiment, the data network 2300 includes a portion of the public Internet. Other networks could be used, either public or private, wireless or wired/optical, and using either the TCP/IP suite of protocols or other protocols. Given its current ubiquity, preferred versions of the invention operate in connection with the public Internet and particular benefits are thereby obtained. However, particular challenges are also posed by operation across open public networks. These challenges are known to those skilled in the art; however in the context of particular applications, particular solutions must be fashioned as illustrated below and in the above-mentioned parent patent application.

The website server system 2100 includes the server application 1140 executing on computing machinery. In some embodiments of the invention, the server application 1140 is an HTTP server. The website server system 2100 may be a single machine or a collection of machines cooperating to fulfill requests for resources, e.g., a load balancing server farm.

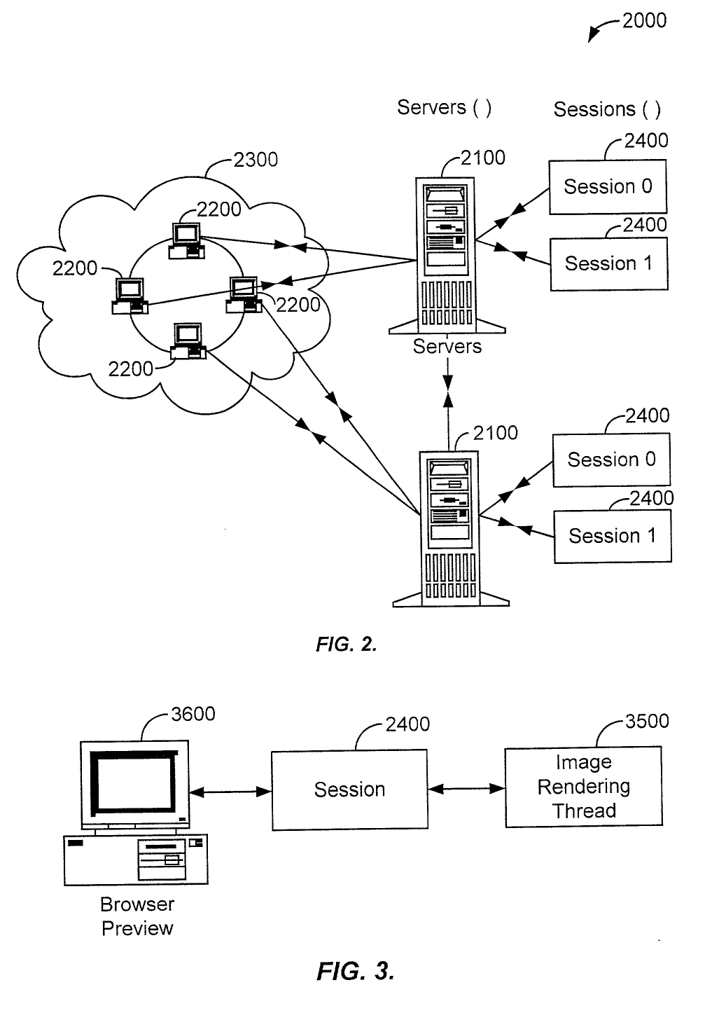

The server system 2100 further comprises image manipulation application logic 1130 for carrying out client-server image editing operations with the remote user's client computer system 2200. These functions are described in more detail below in connection with FIG. 2-FIG. 7. In some embodiments of the invention, the ImageEN product available from Hyrix Technologies, SRL is the tool used for implementing image editing operations.

As noted above in the overview, one aspect of providing item customizing information is through editing of images to be imprinted on the desired item. The discussion below in connection with FIG. 2-FIG. 7 focuses on these aspects.

FIG. 2 and FIG. 3 illustrate a processing architecture for image rendering in accordance with an illustrative embodiment. The website server system 2100 preferably maintains a session 2400 to track sequences of requests from client systems. Each session 2400 is preferably allocated its own image rendering thread 3500 by the server system as performance in image editing and rendering steps may be improved. The server system 2100 need not be multithreaded and heavyweight processes could be used. Further, the server system 2100 is not limited to allocating a single thread for a particular session 2400 and plural threads could be used. For instance, a tiled image architecture could be used and threads separately allocated to each tile of a tiled image in performing editing operations.

The address space for the rendering thread 3500 preferably includes five versions of an image undergoing editing. In operation, a first version is an initial version of the image provided by a user; a second version, Web Image, is a version optimized for viewing on the web; a third version, Print Image is a version optimized for printing; a fourth version, WebTemp is a temporary version for the web where all edits are made and is a current preview version of the image that depicts the results upon completion of a most recent editing operation; and a fifth version, PrintTemp is a temporary version for printing which also has the user made edits and is made in parallel with WebTemp.

Upon an indication from the user to save an edited version of the image (described below), the WebTemp and PrintTemp images are sent to Web Image and Print Image respectively. The user also has the ability to undo the user's edits. The image is embodied in a self-contained object which allows a record of the user's edits to be kept. The user has the ability to undo the user's edits at “n levels”. For example, if the user makes five edits, he can undo all five edits to return to the original image before any editing was done. In an illustrative embodiment, the tool which keeps a record of the user's edits and allows the user to undo the edits is the ImageEN product available from Hyrix Technologies, SRL.

In an illustrative embodiment, Web Image, is optimized for the web, using such formats as JPEG, GIF, and other formats that offer high compression and acceptable image quality. Print Image, is image optimized for printing and lossless image compression formats, e.g., Portable Network Graphics (PNG), are conveniently used.

Web Image is also optimized for display size. Web Image may, in practice, be smaller or larger than the actual uploaded image. The user typically sees a scaled version of the image. Since a user's display has a fixed resolution, for example 800×600 pixels, and web page contents layout can be done in pixels, Web Image contains a version of the underlying image that is scaled to a suitable portion of the screen when rendered as part of a web page on the user's display. Thus, once the image is cropped, it is resized to optimize web image quality. Likewise, there is no reduction in print quality if the image is cropped. Print Image is reduced in the same proportion as Web Image, resulting in optimization of print quality.

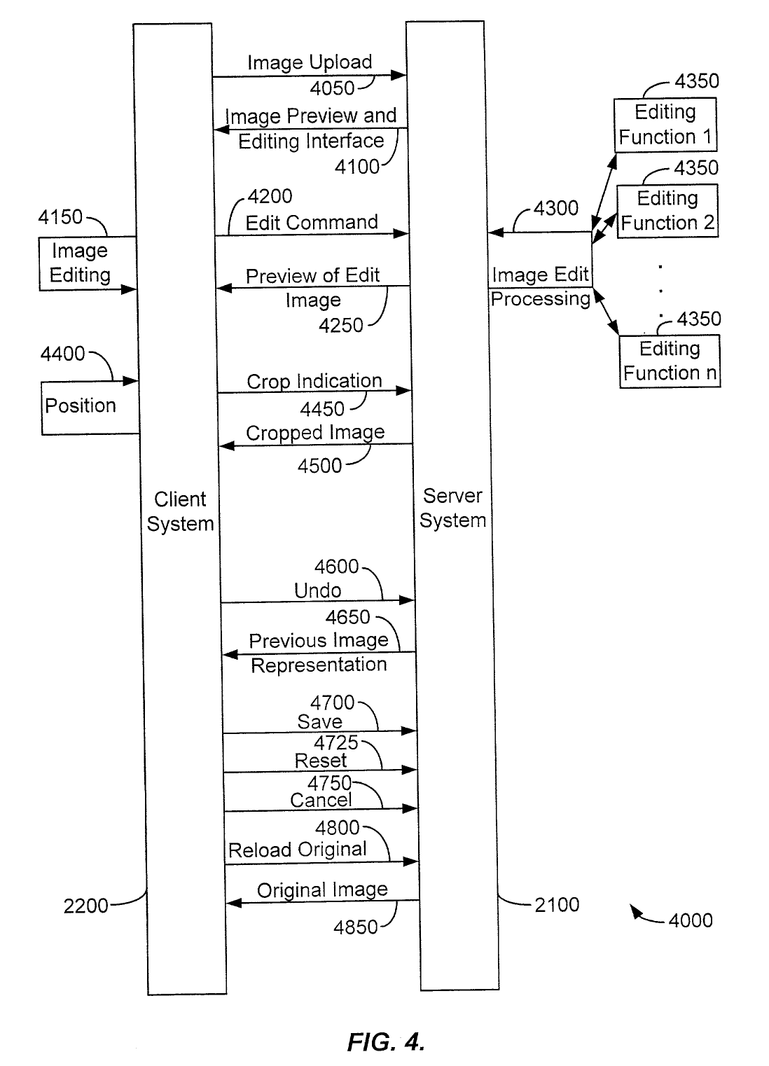

FIG. 4 depicts a data flow diagram of an image editing system 4000 in accordance with an illustrative embodiment. Data flow initiates in an image upload process 4050 where the client system 2200 under control of the user transfers an initial version of an image to the server system 2100. One of skill in the art, having the benefit of this disclosure, will appreciate that no particular image format is fundamental to carrying on the invention. Conventional image formats could be used, and it is contemplated that features of the invention could operate with later-developed image formats. Still further, editing features of the invention could operate with moving images as well as static images.

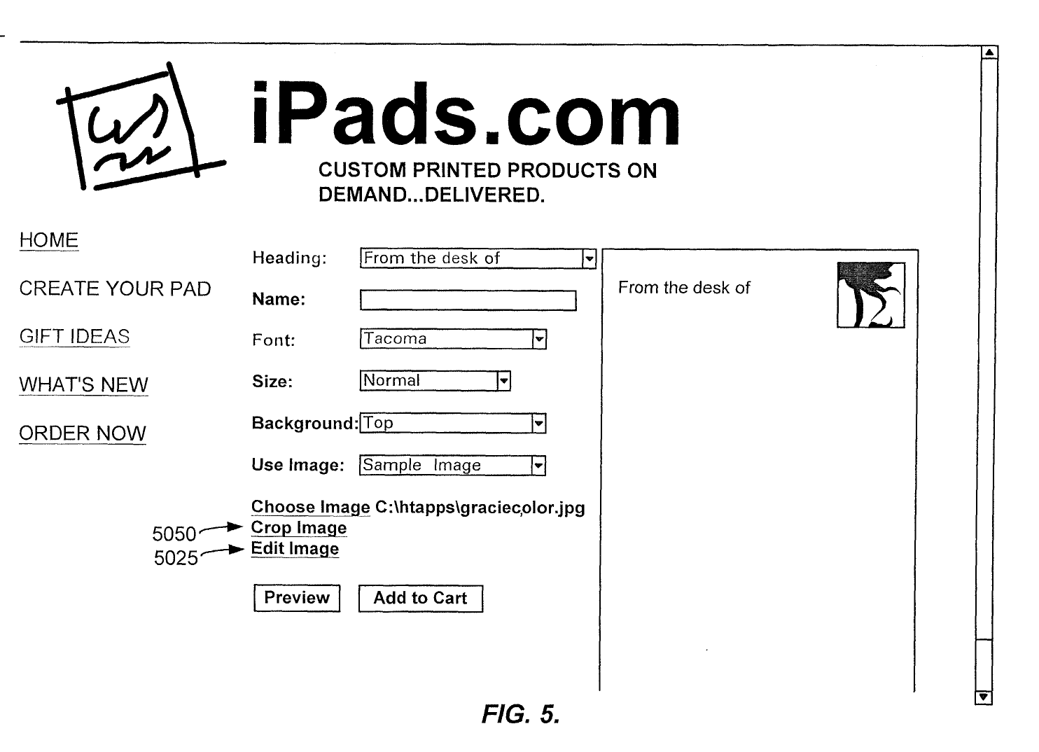

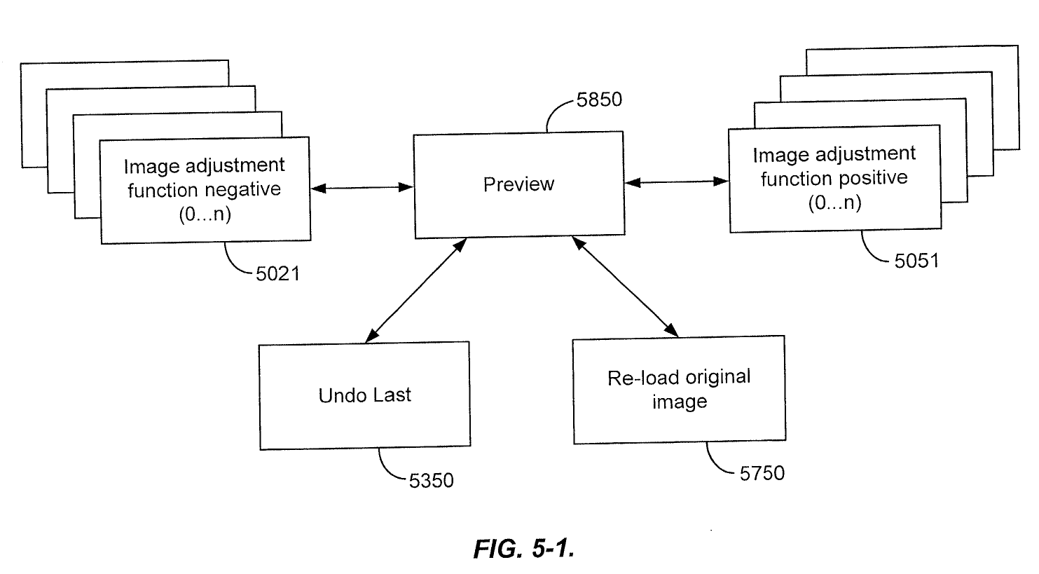

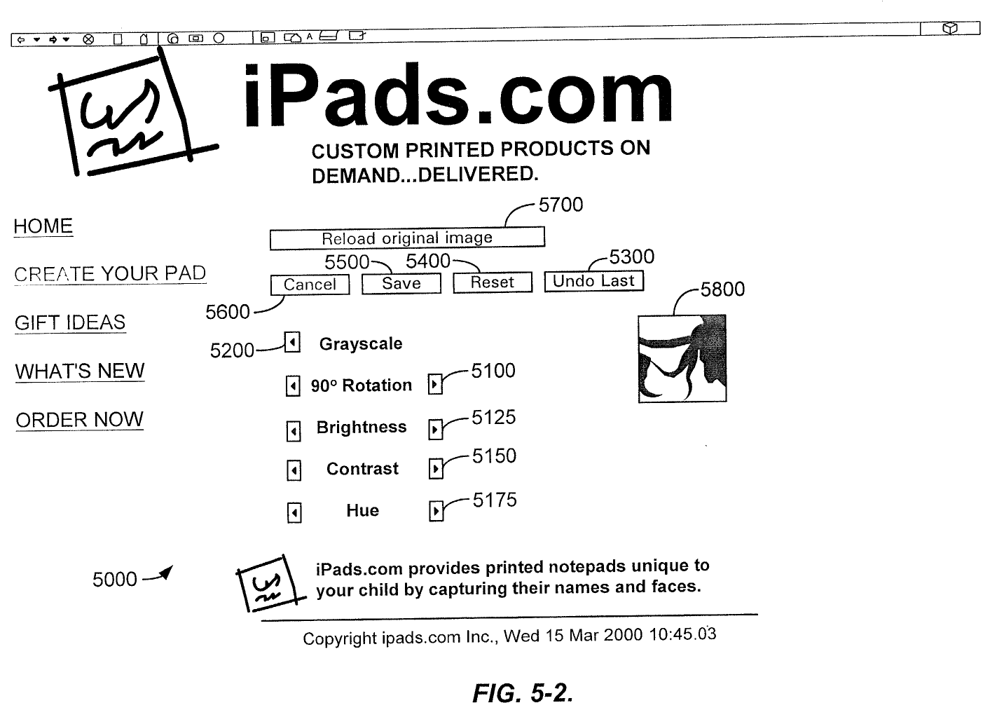

The server system 2100 stores the initial version of the image in the address space for this session 2400. The server system 2100 generates a preview of the initial version of the image (WebTemp), that is stored along with the initial version. In parallel, another image (PrintTemp) is created which has the edits contained in WebTemp. Next, in an image preview and editing interface process 4100, the server system 2100 transmits to the client system 2200 a characterization of an interface for performing editing operations as well as the image preview. After the user has finished the editing session, the image in WebTemp is sent to Web Image, and the image in PrintTemp is sent to Print Image. In illustrative embodiments of the invention the characterization of the interface is with an HTML document. An illustrative image editing interface is described in greater detail below in connection with FIG. 5-2.

Next, the user engages in an image editing process 4150 in which the user selects image editing actions with the image editing interface to generate image editing instructions. The editing process may generally include any of the functions suitable for implementation though the image editing interface. Illustrative embodiments of the invention include parametric editing operations, for instance increasing brightness or contrast and in such embodiments, the image editing process may comprise increasing or decreasing a parameter for image editing, for instance increasing contrast.

More generally, any of several editing functions 4350 may be performed. One skilled in the art is familiar with many editing operations, and having the benefit of this disclosure, will readily apprehend features appropriate for inclusion in an image editing interface for performing that particular editing function 4350.

When the user has completed the image editing process 4150 an edit command 4200 is invoked by selecting a selectable action on the image editing interface to instruct the server system 2100 to perform the indicated image editing operation corresponding to the image editing instructions. The server system 2100 then performs image edit processing 4300 that includes applying the selected editing function 4350 to the image. When image edit processing 4300 completes, the server system 2100 returns the results to the client system 2200 as a preview of the edited image 4250. The user may then select additional image editing 4150, may select a different one of the editing functions 4350, select a crop function as described below, or complete their editing session.

Yet another aspect of the present invention is the ability to provide a crop function to the image editing process. In an illustrative embodiment, the user may select the crop function at any point during the editing process, either before or after other editing operations. A parent screen may be provided, for instance as depicted in FIG. 5 including selectable actions to request interfaces for image editing operations including the crop function.

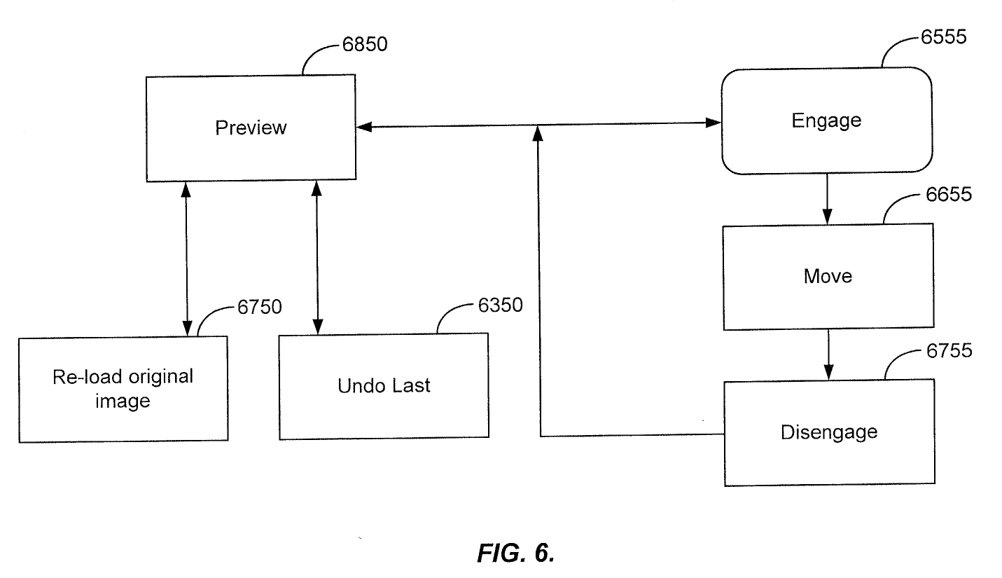

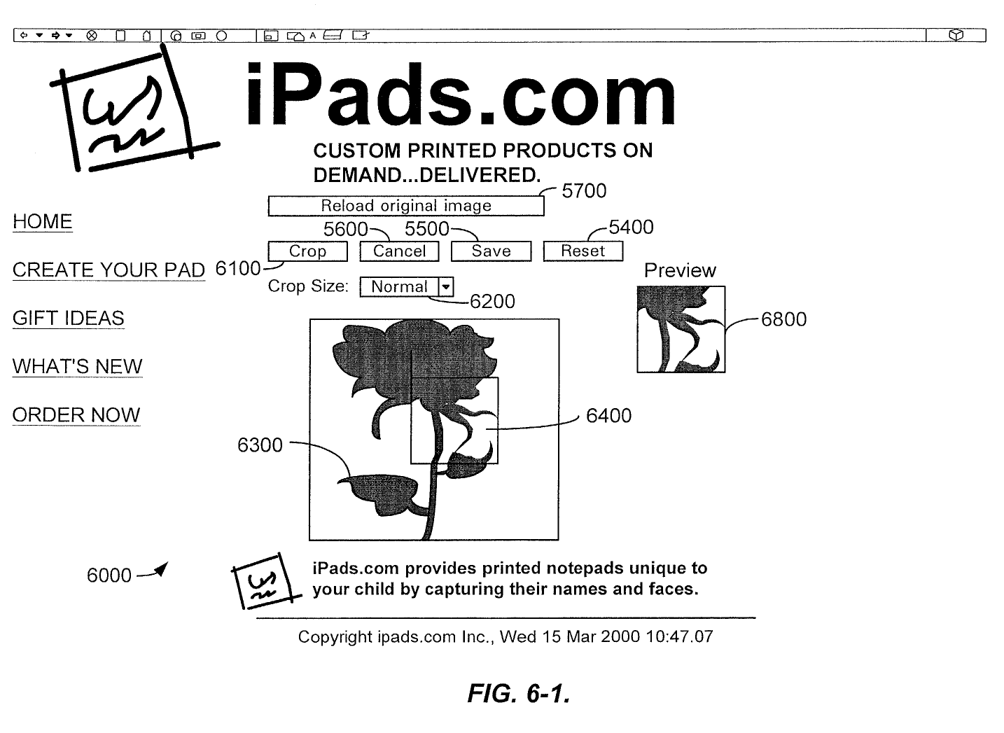

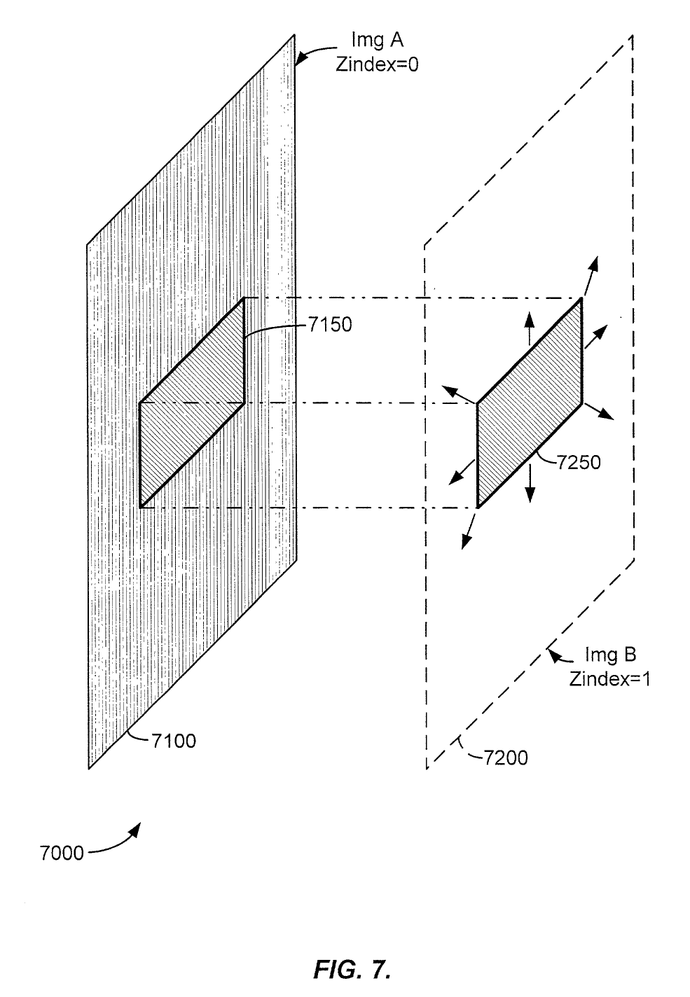

The client system 2200 receives an image cropping interface discussed in greater detail below in connection with FIG. 6-1. Using appointing device, keystrokes, or other instructions, the user performs a positioning process 4400 for selecting a region for cropping. When the user has chosen how they wish to crop the image, the client system 2200 sends a crop indication 4450 to the server system 2100. The crop indication includes cropping information defining a cropping area 6400. For instance if the cropping area 6400 were rectilinear, the cropping information could include a corner of the rectilinear cropping area as well as dimensions of the area. The server system 2200 then crops the image appropriately and returns a cropped image 4500. The user may, for instance, undo the crop, accept the crop, further crop the image, or perform other image editing operations on the cropped image.

As noted, the user may undo the effects of an image editing operation. After an image editing operation, including a crop operation, the client system 2200 under control of the user may send an undo command 4600 to the server system 2100. The image is embodied in a self-contained object which allows a record of the user's edits to be kept, and further allows the user to undo all of the user's edits.

Additional operations a user may select from the editing interface or the cropping interface include a save operation 4700, a reset operation 4725, and a cancel operation 4750. A user may apply multiple image editing operations in one editing session—and may also edit versions of the same image in multiple editing sessions. The save operation 4700 saves any edits made during an editing session up to that time and returns the user to a parent screen for the image editing system. The reset operation 4725 takes the user back to the previous ‘saved’ version of the image. The cancel operation 4750 also returns the user to the previous ‘saved’ version and, like the save operation 4700, returns the user to the parent screen.

Yet another function provided in illustrative embodiments of the invention is reloading the initial version of the image. Editing interfaces are provided with a selectable action for reloading the initial image. When a user selects this action, a reload original command 4800 is sent from the client system 2200 to the server system 2100 which retrieves the initial version of the image from the address space for this session 2400 and returns the initial version 4850 to the client system 2200.

Illustrative image editing operations will now be discussed in connection with FIG. 5, FIG. 5-1, and FIG. 5-2. FIG. 5 illustrates a user view of a parent screen for an image editing system. The parent screen includes a first selectable action 5025 to request an image editing interface and a second selectable action 5050 to request an image cropping interface.

FIG. 5-1 illustrates a process flow diagram of an image editing operation and FIG. 5-2 illustrates a user view of an image editing interface in accordance with an illustrative embodiment. FIG. 5-2 reflects an image editing interface created with conventional HTML as parsed and rendered by a conventional HTTP client or “web browser”. Several image editing operations are available for selection including (i) rotation through 90 degrees 5100, (ii) brightness adjustment 5125, (iii) contrast adjustment 5150, and (iv) hue adjustment 5175. Each of operations (i)-(iv) may be adjusted either positively or negatively. Adjusting these parameters (either positively or negatively) controls the effect of the image editing command. For instance, selecting hue adjustment 5175 in the positive direction increases the hue of the image. In the illustrative embodiment, the increment of adjustment is fixed, that is, each selection of the adjustment action adjusts the effect a static amount. However, the increments of the adjustments could also be user-selectable. An additional editing operation is a grayscale operation 5200 that converts a color representation of an image to a grayscale representation of the image.

FIG. 5-2 also depicts a preview region 5800. The preview region 5800 contains a representation of the image that is updated upon the user selecting one of the image editing operations discussed above. As described in connection with FIG. 3, the image rendering thread 3500 performs image rendering upon receipt of image editing commands and the preview promptly is returned to the client system where it is displayed in the preview region 5800. Referring to FIG. 5-1, a preview process 5850 involves the image rendering thread 3500 rendering a current version of the image in response to an image editing command received from the client system 2200 and returning the results to the client system 2200. When, as in this illustrative embodiment, HTML parsed and rendered by a browser provides an interface to the user, the preview image can be transmitted to the browser as a resource referenced by a conventional IMG tag. Adjustment of image editing operations in either the negative direction 5021 or the positive direction 5051 result in the preview region 5800 on the image editing interface providing a visual indication of the result of the most recent image editing operation.

From the image editing interface a ‘reload original image’ action 5700 is selectable and invokes a reload original image process 5750 that transmits the initial version of the image from the server system 2100 to the client system 2200. Similarly, from the image editing interface an ‘undo last’ action 5300 is selectable and invokes an undo last process 5350 that transmits the previous version of the image from the server system 2100 to the client system 2200. Also depicted are a ‘cancel’ action 5600, a ‘save’ action 5500, and a ‘reset’ action 5400. The ‘cancel’ action 5600 invokes the cancel operation 4750; the ‘save’ action 5500 invokes the save operation 4700, and the ‘reset’ action 5400 invokes the reset operation 4725.

An illustrative embodiment of a crop image editing operation will now be discussed in connection with FIG. 6 and FIG. 6-1. FIG. 6 depicts a process flow diagram of the crop image editing operation and FIG. 6-1 illustrates a user view of a crop image editing interface 6000. FIG. 6-1 reflects a crop image editing interface 6000 created with conventional HTML as described below as parsed and rendered by an HTTP client supporting Cascading Style Sheets (“CSS”).

The crop image editing interface 6000 shares certain common features with the image editing interface 5000. Common features include the ‘reload original image’ action 5700, the ‘cancel’ action 5600, the ‘save’ action 5500, the ‘reset’ action 5400 discussed above in connection with FIG. 5-2 and the preview region 5800. In addition, the crop image editing interface 6000 includes a crop size selector 6200, a ‘crop’ action 6100, an image 6300 and the cropping area 6400.

The crop size selector 6200 provides a menu of user-selectable sizes for the cropping area 6400. It is not fundamental that predetermined sizes of the cropping area 6400 be used and this area could be arbitrarily selected. The cropping area 6400 is visibly distinguished from the remainder of the image being cropped. In FIG. 6-1, the cropping area 6400 has a greater brightness; this is not fundamental however and one skilled in the field will readily appreciate that any number of means could be used to visibly distinguish the cropping area 6400 including, for instance, greater darkness on a lighter background, a border, or corner indicators.

The ‘crop’ action 6100 sends a request to the server system 2100 to crop the image 6300 to that portion coincident with the cropping area 6400. The cropping area 6400 is positionable within the dimensions of the image 6300. FIG. 6 depicts process flow in which the user engages 6555 the cropping area 6400 with, for instance, a pointing device. The particular manner of engaging the cropping area 6400 is not fundamental. Some embodiments include, for instance, engaging the cropping area 6400 by depressing a mouse button with a cursor positioned in the cropping area 6400—the user may, or may not, ‘drag’ the cropping area 6400, i.e. keep the mouse button depressed. The user may then move 6655 the engaged cropping area 6400 for determining a desired portion of the image 6300 for cropping. When the user has completed positioning, the user disengages 6755 the cropping area 6400, by, for instance, clicking again, or releasing the depressed mouse button when dragging. When the cropping area 6400 is disengaged, the preview region 6800 shows the resulting cropped image. As previously noted, the user may select the ‘reload original image’ action 5700.

In operation, an illustrative embodiment involves the user first selecting a size of the cropping area 6400 with the crop size selector 6200. The user then engages the cropping area 6400 and positions it within the image 6300. When the user determines a suitable position for the cropping area 6400 it is disengaged. The preview area 6800 shows the cropped image. The user may then select, for instance, the ‘crop’ action 6100 to place the cropped image as the current image representation.

A beneficial aspect of the crop image editing interface 6000 is that it may be implemented in a completely open manner employing interoperable standards found in conventional web browsers.

In an illustrative embodiment, cascading style sheets (CSS) and JavaScript/ECMA Script (hereinafter “JavaScript”) are used for creating and positioning the cropping area 6400 within the crop image editing interface 6000. One skilled in the art will appreciate that the current generation of CSS-enabled browsers vary in implementation of the CSS standard(s) and that known techniques exist for creating logic for popular browsers including, for instance MICROSOFT Internet Explorer, NETSCAPE Navigator, and the Opera browser.

In the illustrative embodiment, JavaScript is used to dynamically manipulate CSS properties in response to user input to provide a positionable image cropping area 6400. In accordance with the illustrative embodiment, FIG. 7 illustrates two CSS layers with different representations of an image. A first representation of the image 7100 is darkened. The first representation of the image 7100 is in its own CSS layer created by a DIV tag. An ID attribute of the DIV tag identifies each representation of the image and in the pseudo code in Tables 1-6 below the first representation of the image 7100 is identified in the pseudo code as an image object ImgA. A second representation of the image 7200 is identified as image object ImgB. The second representation of the image 7200 is also in its own CSS layer. However it is nested within the DIV tag of the first representation of the image 7100.

CSS layering allows plural objects to occupy the same physical location when rendered by a CSS-compliant browser. For each pixel, when plural objects could contribute to that pixel, the object that is displayed by the browser is the object that has the highest CSS z-index. In addition, the properties of CSS layering allow for any sub-layer to display when rendered provided that no layer with a lower z-index occupies the same pixel.

In the illustrative embodiment, the first representation of the image 7100 has a z-index of 0 and the second representation of the image 7200 has a z-index of 1. Using CSS, the first representation of the image 7100 and the second representation of the image 7200 are superimposed. More particularly, they are placed at the same location in a web page and assigned different layers (z-indexes).

The second representation of the image 7200 is clipped and FIG. 7 shows a clipped region 7250. Clipping is a visual effect that defines which portion of the second representation of the image 7200 is visible. The CSS Clip property of the second image representation 7200 is set to define the clipped region 7250. The clipped region 7250 implements the cropping area 6400 discussed above.

The portion of the second representation of the image 7200 outside the clipped region 7250 is transparent. This is achieved by setting the CSS clipping values. The visual effect of this is that the first representation of the image 7100 that is at a lower layer is visible outside of the clipped region 7250. The portion of the first representation of the image 7100 coincident with the clipped region 7250, namely region 7150, is not visible. This may be seen, for instance, with reference to FIG. 6-1, where portions of the image 6300 outside the cropping area 6400 are shaded darker.

The position of the clipped region 7250 may be changed by redefining the Clip properties of the second representation of the image 7200. By redefining the Clip properties responsive to user input in real-time, real-time dynamic positioning of the clipped region 7250 is provided to the user. The visual effect to the user is that he or she may reposition a lightened cropping area 6400 within the image 6300. The cropping area 6400 is lightened in that the first representation of the image 7100 is a darkened version of the second representation of the image 7200. The first representation of the image 7100 is visible as the second representation of the image 7200 is transparent outside the clipped region 7250.

The cropping area 6400 thus is positionable through dynamic repositioning of the clipped region 7250. In an illustrative embodiment, dynamic repositioning of the clipped region 7250 is achieved through the use of client-side JavaScript events. In the following tables, pseudo code illustrative of an embodiment of the invention is provided. In Table 1, variables are initialized and the methods shown in Tables 2-6 setup to be invoked upon events.

TABLE 1

Procedure Init;

Begin

ImgB.onMouseDown = engage;
ImgB.onMouseMove = move;
ImgB.onMouseUp = trueDraggingDisengage;
ImgB.onMouseOut = disengage;
ImgA.onMouseOut = disengage;
Mouseup : boolean = true;
AlreadyEngaged : boolean = false;
CurrentX : integer = 0;
CurrentY : integer = 0;
SelectedObj : object = null;
TrueDragging : boolean = false;

End;

Table 2 illustrates an ‘engage’ method invoked when a ‘mouse down’ event is detected in Img.

TABLE 2

Procedure engage(evt : eventObject);
Begin

If alreadyEngaged then
Begin

Disengage;
Return;

End;
If setSelectedElement(evt) then //get object clicked on and set

it in SelectedObj (always ImgB)

Begin

alreadyEngaged = true
mouseup = false
currentX = evt.locationX; // absolute horizontal location of

pointer event

currentY = evt.locationY; // absolute vertical location of

pointer event

end;

end;

Table 3 illustrates an ‘disengage’ method invoked when an event is detected in Img A or Img. B. indicating the user has disengaged the selection area.

TABLE 3

Procedure disengage(evt : eventObject);
Begin

Engaged = false;
Truedragging = false;
SelectedObject = false;
//Logic to set cropping values at point of disengagement

End;

Table 4 illustrates an ‘TrueDraggingDisengage’ method invoked when an event is detected in Img. B. indicating a user that was dragging the selection area has disengaged the selection area.

TABLE 4

Procedure TrueDraggingDisengage(evt :eventObject)
Begin

If TrueDragging then
Begin

Truedragging = false;
Mouseup = true;
Disengage(evt);
Return

End

Else
Begin

Mouseup = true
TrueDragging = false
End;

End;

Table 5 illustrates a method that dynamically changes the clipped region 7250 and thus the cropping area 6400, to the location pointed to by the user. It will be appreciated that it is possible for the user to accelerate a pointer out of the cropping area 6400 faster than the event “move” is called. In this case, the method in Table 5 exits without moving the cropping area 6400.

TABLE 5

Procedure moveCropTo(obj : object; distanceX, distanceY :

integer);

Begin

if (obj.clip.top + distanceY < 0) then

return false

else
if (obj.clip.bottom + distanceY > imgA.height) then

return false

else
if (obj.clip.left + distanceX < 0)

return false

else
if (obj.clip.right + distanceX > imgA.width)

return false

else
// maintain same ratio from old settings. i.e. size of crop

doesn't change

begin

obj.clip.top += distanceY
obj.clip.right += distanceX
obj.clip.bottom += distanceY
obj.clip.left += distanceX

end;

End;

Table 6 illustrates a ‘move’ method invoked when an event is detected in Img. B. indicating a user is moving an engaged the cropping area.

TABLE 6
Procedure move(evt : eventObject);
Var NewX,NewY,DistanceX,DistanceY : integer;
Begin

If selectedObj <> null then
Begin

If NOT mouseUp then

TrueDragging = true

NewX = evt.LocationX;
NewY = evt.LocationY;
DistanceX = NewX − CurrentX
DistanceY = NewY − CurrentY
CurrentX = NewX
CurrentY = NewY
MoveCropTo(selectedObj, DistanceX, DistanceY)

End;

End;

Referring back to the system architecture of FIG. 1, the server system 2100 also comprises HTML documents and other resources 1110 for generating pages to provide to the remote user's web browser 1020. Static files as well as any server side script or programming architectures for dynamic page generation could be used. Server side script or programming architectures for dynamic page generation are preferably used for generating interfaces (when parsed and rendered by the web browser 1020) for receiving input from the remote user. In an illustrative embodiment, the Webbroker server side script architecture available from Borland Corporation of Scotts Valley, Calif. is used for generating interfaces for receiving input from the remote user. This remote user input includes information for selecting and customizing a desired item including image data.

The server system 2100 also includes an object model 1120 acting as an object storage for image data and other information provided by remote users during their sessions. Storage may be persistent; however, preferred versions of the invention employ a relational database 1200 for persistent storage only after the transaction is completed by credit card or other form of electronic settlement. The object model 1120 communicates with the server application 1140, the image manipulation logic 1130 and the HTML documents and other resources 1110 during the remote user's sessions to receive and store user data as well as provide such data in connection with dynamic page generation and image editing operations.

The relational database 1200 includes a catalog of items available for selection by the remote user. Additionally, the relational database 1200 stores information provided by the remote user when customizing the desired item after the transaction is completed. Prior to the transaction being completed, this information is stored by the object model 1120. Further, the relational database 1200 stores resource planning information for efficient fabrication, tracking, and order fulfillment for commercial volumes of customized desired items.

In some embodiments, user customization of imprinted items occurs via the user choosing or supplying the content of a part or sub part of an item. Further illustrative of such embodiments is a schema for the relational database 1200 that facilitate, the creation, tracking, and fulfillment of orders for user customized items. A summary of the schema of the relational database 1200 used in some embodiments follows. One skilled in the art having the benefit of this disclosure will appreciate the schema is illustrative, not limiting, and among others which could be made.

This schema includes a bill of materials (“BOM”) table used to determine which generic parts and sub-Parts are needed for a particular customized desired item. The BOM table is used to generically (but specifically) define orderable Parts. The BOM table includes information as to what needs to be collected for a particular Part. Each entry in the BOM table has a ParentPartID field that points back to its parent part. The combination of all entries with equal ParentPartIDs represents the materials list for that ParentPartID. ParentParts can be nested so that one orderable part is a sub-Part to yet another orderable part. In this case, traditional iteration and recursion can be used to build a representation of the Materials.

A Parts Table defines Parts by a unique ID and by a generic PartTypeID. Unlike certain fields, e.g., price or weight, the PartType defines what customizing information is to be collected or verified. Individual Parts can share the same PartType. A normalized PartType table stores a unique PartTypeID and description for PartTypes. Each PartType can have one or more PartTypeAttributes defined for it. A PartTypeAttributes table is a list of all Attributes to be collected for a particular PartType. Each PartTypeAttribute defined for a PartType provides an ability to collect multiple attributes as well as define a default attribute value for that particular PartType (and thus a given Part). An Attributes Table defines generic pieces of data that can be collected in connection with user customization. Each attribute has a description and a generic default value. Examples of Attributes include, for instance: FileName, Text, Font, Color, etc. An example list of attributes that would be used by the PartType “Text” might be: Text (the text itself), Font, Color and Size.

As described above, the Parts system characterizes each Part and its sub-Parts and (via the BOM table) defines what information needs to be collected for customizing a particular desired item. An Orders portion of the schema provides for actual storage of information for fabrication of the Parts that have been customized. An OrdersTable represents a collection of orderable Parts (like or dislike) that have been ordered as part of one session or one transaction. An OrderID is a master reference used within the fabrication system, including shipping (described in more detail below).

Each customized item ordered has an entry in an OrderLineItems Table. An OrderLineItemID in the OrderLineItems Table is used as a globally unique ID that points a particular ordered Part back to its Order in the Order Table. Preferably, only orderable Parts are allowed in the OrderLineItems collection—their required sub-parts conveniently stored, normalized, in an OrderMaterials Table. The OrderMaterials table entries represent one or more sub-parts needed for each particular ordered Part. The OrderMaterials contents for a particular OrderLineItem mimics that of the BOM table described above. For each entry in the BOM, table with a given Parent PartID (matching the ordered Part) there exists an entry in the OrderMaterials table.

For each sub-Part in the OrderMaterials table there are one or more entries in a normalized OrderPartAttributes table. Preferably there is exactly one entry for every Attribute that needs to be collected for a given Part. The OrderPartAttributes table is the ultimate storage location of the actual customized data for all sub-Parts. The data itself is treated as a variant and is stored in a generic field titled Value. If the Value is blank, the default value from the PartTypeAttributes Table is used, or if that is also blank, the default from the Attributes Table is used.

A Customers Table stores Customers by a unique ID. A CustomerShipTo table stores shipping addresses for Customers as its entries. For each Customer in the Customers table there are one or more entries in the CustomerShipTo table. This allows a particular customer to define a plurality of locations to which shipments may be made.

Each Part has one or more entries in a PartShippings table. Each entry allows a particular Part to be shipped via the specified ShippingType and ShippingRule. Each entry also defines a the markup cost for shipping that Part via the specified ShippingType and Shipping Rule. A ShippingTypes table defines different shipping carriers used for delivery, e.g. Federal Express, by a unique ID. Each shipping carrier defined in the normalized ShippingTypes table has one or more shipment rules. These rules specify the methods of shipment available to a ShippingType, e.g. Overnight Express.

An OrderShippings table defines actual Product shipments. Each OrderLineItem has one or more entries in the OrderShippings table. Each entry specifies the CustomerShipTo location where the orderable Part will be shipped, the ShippingType defining which carrier will ship the Part, the ShippingRule defining which method of shipment will be used with the carrier, and the quantity of the Part to be shipped. Parts can be grouped based quantity into individual shipping destinations where the sum of each quantity must match the original OrderLineItem Table Entry quantity.

Entries in a CustomerBillTo table contain billing profiles for Customers. For each customer in the Customers table, there are one or more entries in the CustomerBillTo table. This allows a particular customer to define a plurality of billing profiles to use for paying orders.

Entries in a CustomerContacts table contain identities that a given Customer may assume. Each customer in the Customers table has one or more entries in the CustomerContacts table. This allows a particular customer to have more than one identity, e.g. the many employees of a business client or individual divisions of one main customer.

An OrderBillings table defines the actual payments for an order. Each Order has one or more entries in the OrderBillings table. Each entry specifies an Amount to bill and a CustomerBillTo billing profile for which to bill for the Amount. The collection of CustomerBillTo entries for each Order will determine how an Order is paid. This feature allows multiple billings to one client where that client may have individual departments each with an Accounts Payable department.

Returning again to FIG. 1, a collection of item characterizations 1330 represent generic “templates” for particular item types. That is, the item characterizations 1330 contain the information to be used in creating the desired item other than information susceptible to specification by the remote user. Taking, by way of example, a 50 sheet notepad as a type of desired item, the item characterization could include a document template. For other types of items, other types of item characterizations would be appropriate. The particular item characterization will ordinarily be determined by the item and the requirements for fabricating a customized version of that item. It is contemplated that items other than printed items susceptible to item characterization by document template can be created in accordance with our invention.

In some embodiments, for each desired item there exists a predetermined item characterization 1330. It is contemplated that semantic information for the item characterizations 1330 could be, in whole or in part, contained in the item characterization 1330. In particular, it is contemplated that the item characterizations 1330 could be self-describing. As can be appreciated by one skilled in the field, a self-describing item characterization would reduce or eliminate the need for a predetermined item characterization and would characterize the item straight from the user specified information in real time. All needed parameters for an item's template could be provided by a user. The server system 2100 could determine what item-customizing information needs to be gathered for the particular item and create purely dynamic pages that would include appropriate input interface components for gathering this information from the user.

In an illustrative embodiment of a self-describing template, a user would input parameters of a desired item, for example, a notebook. Values such as height, width, and location of the image, as well as the number of pages and size of pages would be input by the user in. response to prompts. These and other entries would be recognized as parameters of a notebook and the notebook would be created based on the user's inputted values. Conveniently, in such embodiments, predefined templates could be reduced or eliminated. As will be appreciated by one skilled in the field having the benefit of this disclosure, programmed instructions could be used to programmatically represent the self-describing template. Embodiments of the invention employing self-describing item characterizations 1330 would provide substantial flexibility, and customizability to the remote user when specifying the desired item. Referring back to the notebook example, the user could specify any location on the notebook where the user would want to place the image, as well as have greater flexibility in specifying the size of the image. All configurable aspects of a self-describing template can be user configured.

Referring back to the flow diagram of FIG. 1, a customizing application 1300 performs the function of generating a characterization of the customized desired item. The customizing application 1300 merges user-provided customizing information stored in the relational database 1200 with the appropriate one of the item characterizations 1330 corresponding to the desired item of the remote user. Responsive to these two inputs, the customizing application 1300 generates a characterization of the remote user's particular customized desired item. For embodiments generating printed items, a variable print software tool such as ReportBuilder (available from Digital-Metaphors of Addison, Tex.) could be used to programmatically create the output. For such printed item embodiments, the customizing application 1300 could generate PostScript (PS—by Adobe Systems Incorporated), Portable Document Format (PDF—by Adobe Systems Incorporated), Variable Postscript (VPS—by Creo SciTex Corporation), Variable Data Intelligent Postscript Printware (VIPP—by Xerox Corporation), or other Print Description Language (PDL) output files with page description information for printing devices as is known in the art. As will be appreciated, the described page provides a characterization of the customized desired item to a compatible printing device. Conveniently, in some embodiments, the customizing application 1300 generates an output file for a printing device that includes information characterizing several desired items of like type, each customized in a separate manner (e.g., to separate users). In this way, fabrication efficiencies can be obtained, thus lowering costs and providing commensurate competitive advantage.

In some embodiments the customizing application 1300 operates with a pre-processing application 1220 and/or a post-processing application 1250.

The pre-processing application 1220 and the post-processing application 1250 can provide, in effect, an interface function between the customizing application 1300 and the other “upstream” and “downstream” components of the system architecture 1000. Depending on the particular desired item and item characterization 1330, the corresponding customizing application 1300 may not readily accept information as retrieved from the relational database 1200. The pre-processing application 1220 can perform any necessary translation of information and employ a mirrored database 1230 usable with the customized application 1300. Analogously, the particular output format of the customizing application 1300 may beneficially undergo transformation for optimal use with any downstream fabrication system. The post-processing application 1250 performs any translations or transformations required. For instance, in some embodiments, the post-processing application 1250 converts files in the PostScript language to raster data for direct use by a production digital printer.

From the customizing application 1300 (and after any post processing employed) the characterization of the customized desired item passes to a fabrication system 1400. The fabrication system 1400 generates the physical embodiment of a customized desired item 1500. The particular fabrication system 1400 used will ordinarily vary with the particular item being fabricated. The fabrication system 1400 is not limited to one machine or step, and rather may include several steps carried on by distinct machines. As noted above, some preferred embodiments of the invention generate printed notepads. In some embodiments, the fabrication system 1400 includes a high performance digital printer such as the Xerox Docu 2060 as well as equipment for cropping, and assembling notepads. One skilled in the art will, of course, appreciate that features of the present invention are not limited to embodiments for creating printed notepads. To the contrary, other items suitable for customized fabrication could be created.

A further illustrative example is a book, such as a children's story book. Digital images such as photographs could be added to the book, or names of characters in the book could be changed to personalize the book. In still other embodiments, the book's plot or story could be changed, as desired by the user. Still further illustrative examples include but are not limited to notebooks, coffee cups, t-shirts, and similar items a user may want to customize.

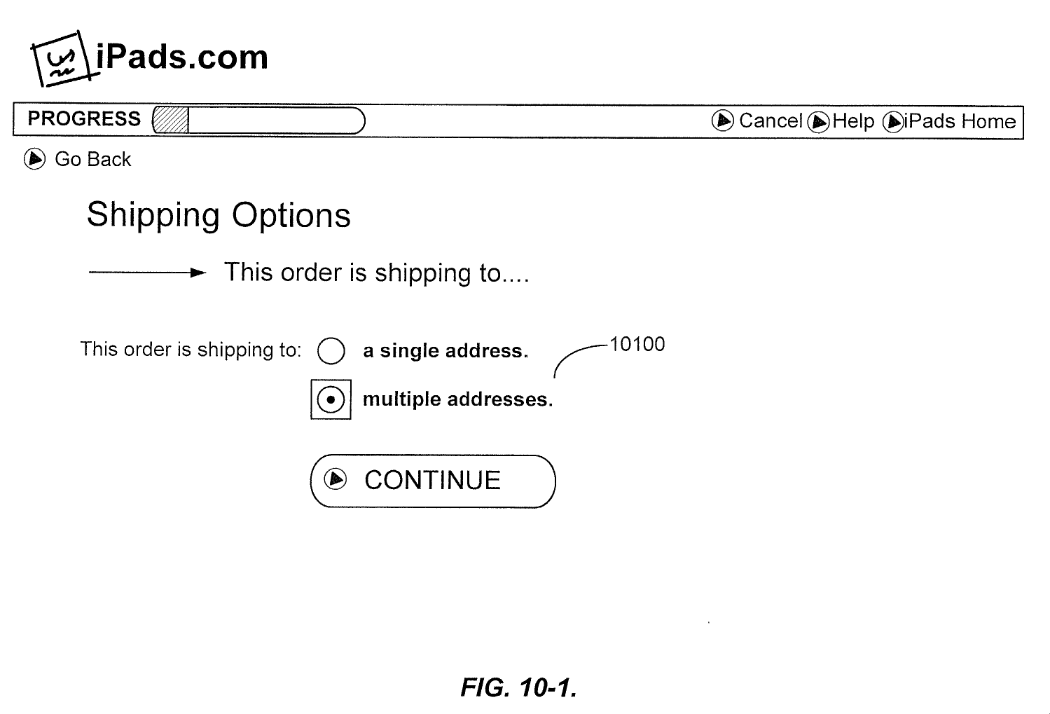

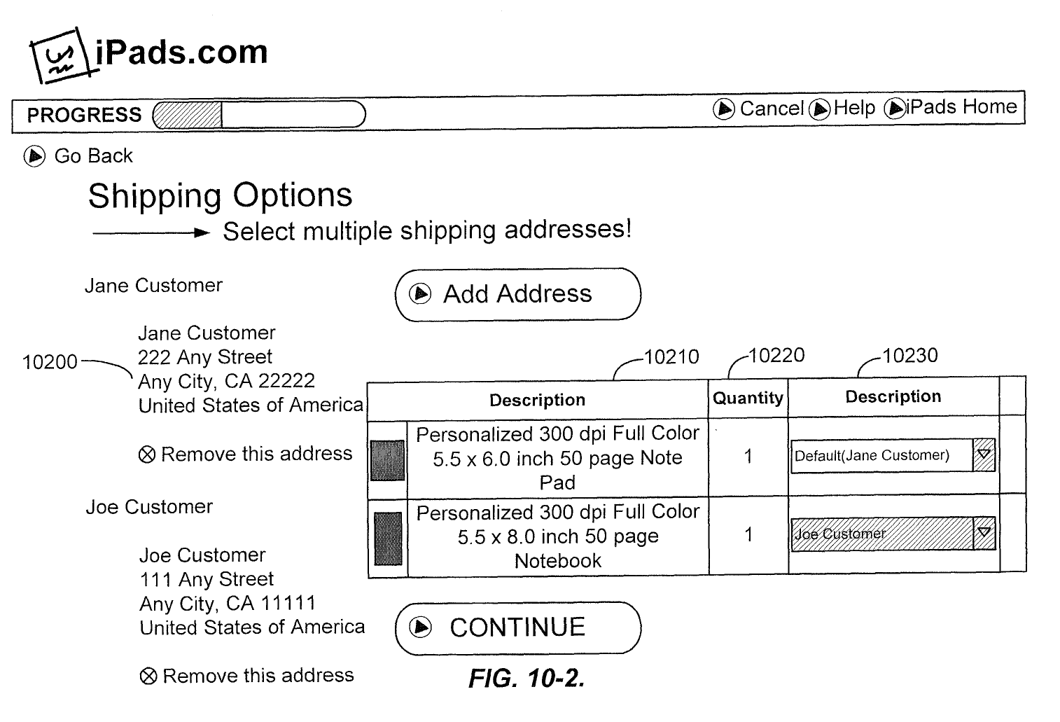

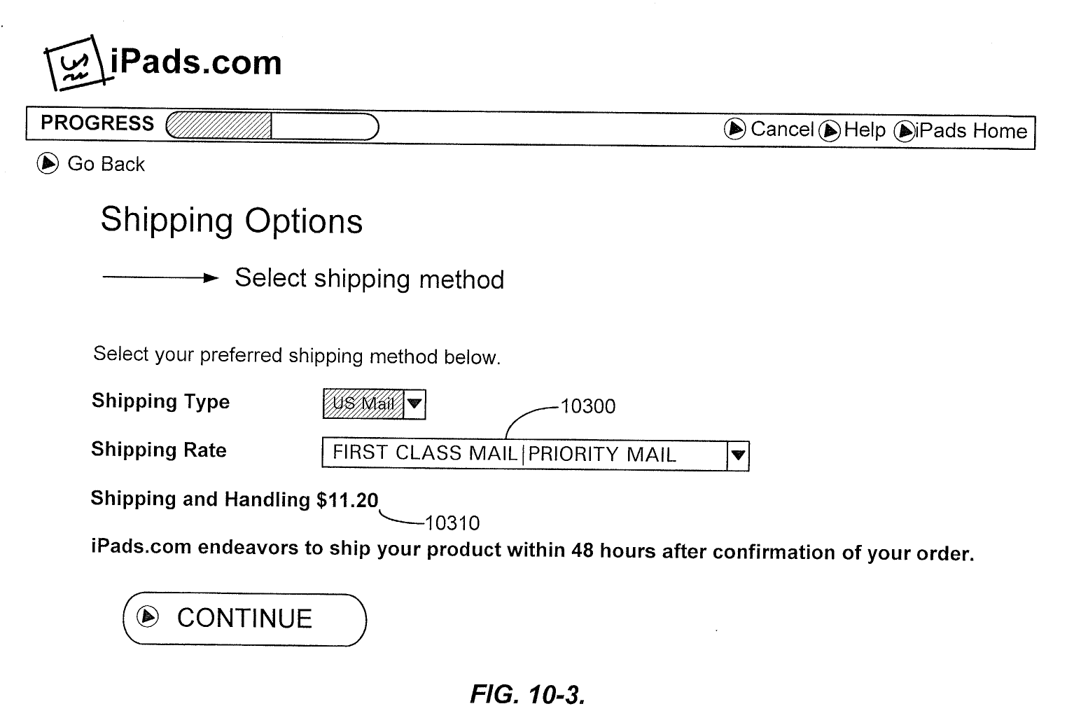

After fabrication, the customized desired item 1500 is provided to the remote user through conventional fulfillment infrastructure 1600. FIGS. 10-1 to 10-3 illustrate user views of interfaces to access the multiple shipping feature. FIG. 10-1 depicts a user interface allowing the user to select whether the user wants the product(s) shipped to a single address or multiple addresses 10100. FIG. 10-2 depicts a user interface illustrating a customer address book 10200, description of selected products 10210, quantities of the selected products 10220, and their destinations 10230. FIG. 10-3 depicts a user interface allowing the user to choose a method of shipping 10300. Based upon the particular shipping method and the particular shipping destination, a shipping and handling rate is immediately calculated and displayed 10310 to the user.

Thus, embodiments of the present invention allow a remote user to select multiple items per session (and is not limited to just one item type per session). Some embodiments of the invention allow the remote user to specify a number of destination addresses, each with separate shipment quantities of each of one or more of the customized desired items 1500 ordered during the session. Embodiments of the present invention thus allow the customized desired item(s) to be delivered to the user(s) conveniently, within one day or a few days, depending upon the method of shipment selected.

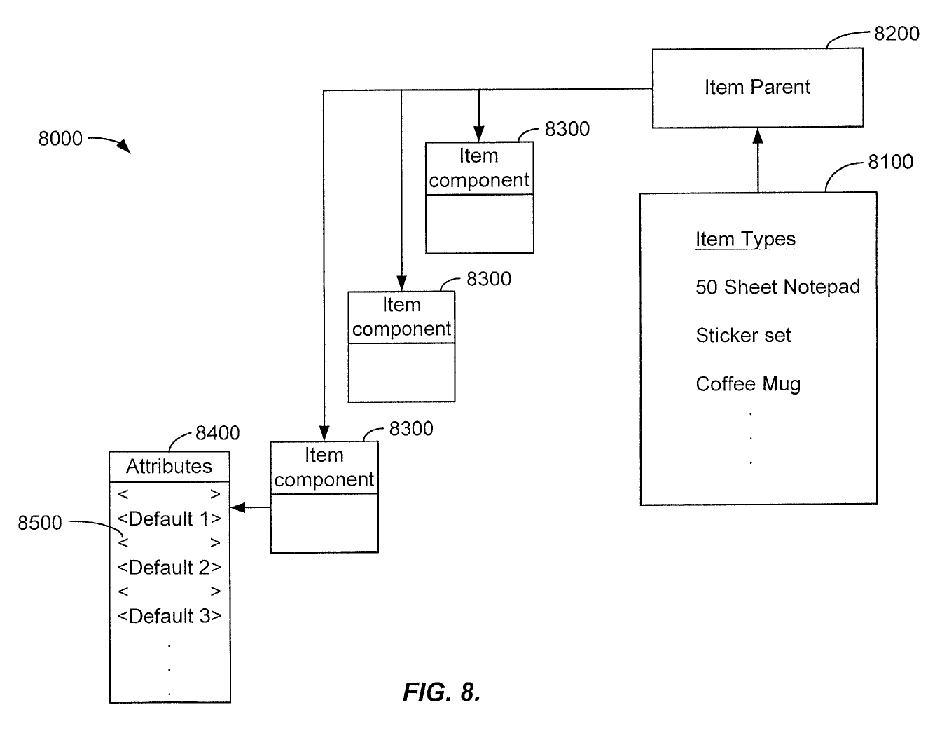

FIG. 8 depicts item components and attributes for user customization in accordance with an illustrative embodiment of the invention. A catalog of item types 8100 illustratively lists, a 50 sheet notepad, a sticker set, and a coffee mug as available for selection. The remote user could be provided an interface through the web browser 1020 as is known in the art for selecting among item types in the catalog of item types 8100. Each of the item types may have several constituent components 8300 which the remote user may customize. The particular constituent components can vary from item type to item type. Further, an item type could be a constituent component of yet another item type. For example if a first item type were the 50 sheet notepad, a second item type could be a stationery set comprising the 50 sheet notepad, as well as envelopes, and a writing instrument.

When the remote user has specified the type of the desired item, the website server system 2100 determines for which constituent components 8300 the type of desired item is an item “parent” 8200. In other words, the server system 2100 determines those constituent components 8300 that need to be specified for creating a version of an item of that type. The server system 2100 provides interfaces to the remote user via the web browser 1020 to provide customizing information for each of the constituent components 8300. Each of the constituent components 8300 may include one or more attributes 8400 which can be customized by having a value 8500 assigned to that attribute by the remote user. Default values could also be set for the attributes 8400 for mere approval by the remote user. At least one of the constituent components 8300 includes image data. In some embodiments the remote user provides the image data; in some embodiments a menu of images is provided and the remote user may select from the menu.

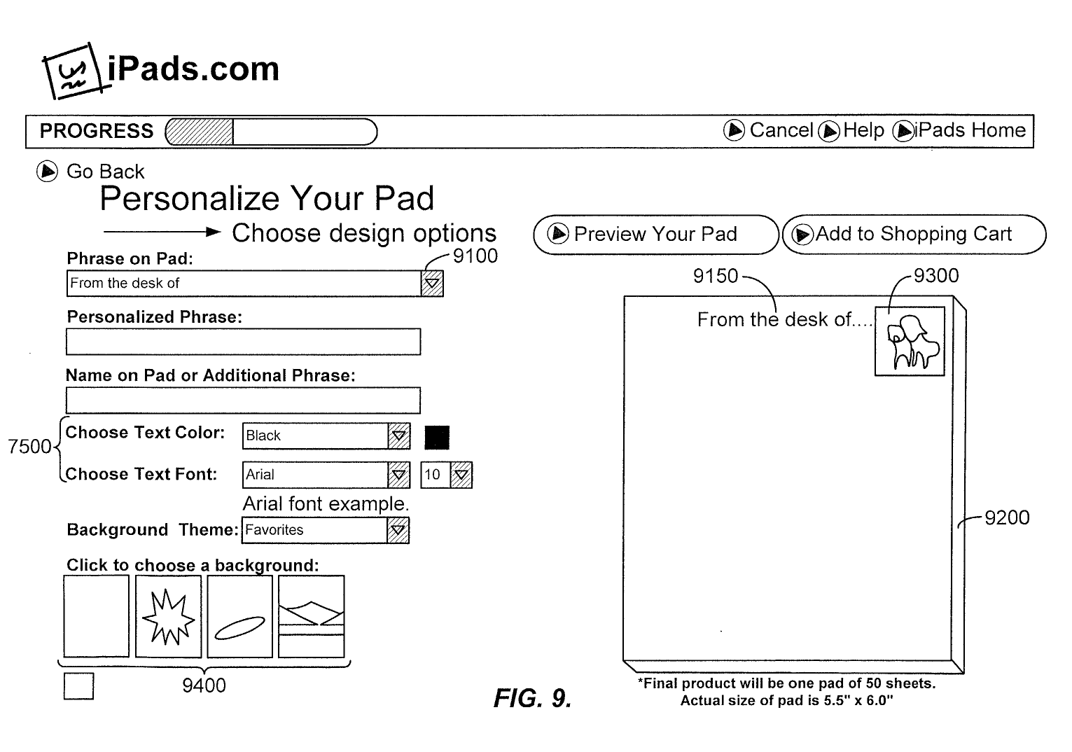

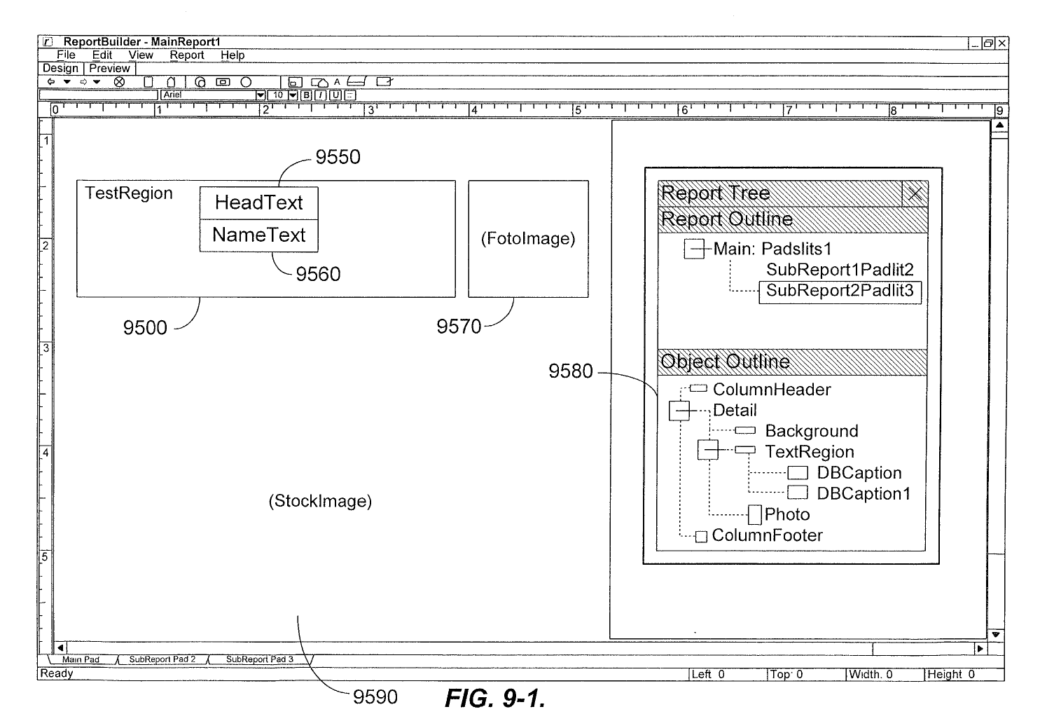

FIG. 9 depicts a user interface for provision of item-customizing information in an illustrative embodiment of the invention. The specification of the value 8500 of attributes 8400 may be carried on in this manner. As can be seen in FIG. 9, the type of desired item that has been selected by the user is a notepad 9200. A first constituent component 9300 is a foreground image specified by the remote user. A second constituent component 9400 is a background image. A third constituent component 9150 is a caption text (“from the desk of”) in FIG. 9. A selection menu 9100 allows specification of the contents of the caption text. A plurality of attributes 9500 are shown for the third constituent component 9150 as well as their default values. As shown in the figure, text color and font are attributes of the text of the third constituent component 9150 with default values of “Black” and “Arial,” respectively. In some embodiments, HTML pages (either a static collection or dynamically created to suit the information to be collected) could be used for each type of item for soliciting item-customizing information from the user.

FIG. 9-1 depicts a further illustrative embodiment of a user interface for a customizing application using ReportBuilder. The figure shows a notepad with a text region 9500 which allows the user to customize the notepad. Within the test region is a section for header text 9550 and name text 9560. There is also a section for an image 9570, which allows the user to customize several different notebooks by changing the image. The background 9590 can also be customized. An outline of the customizing application's various categories 9580 is also shown, which gives an overview of the different categories customized by the user or used by the application. Of course, as one skilled in the field will appreciate, the overview above is illustrative of one embodiment of the invention and not limiting of the invention which is defined by the claims.

In other embodiments, the server system 2100 could determine what item-customizing information needs to be gathered for the particular item in real-time, and create dynamic pages that would include appropriate input interface components for gathering this information from the user. In this case, there would be no text file existing for a particular self-describing item. The server system would collect the required information from the user via user prompts to generate the required self-describing item.

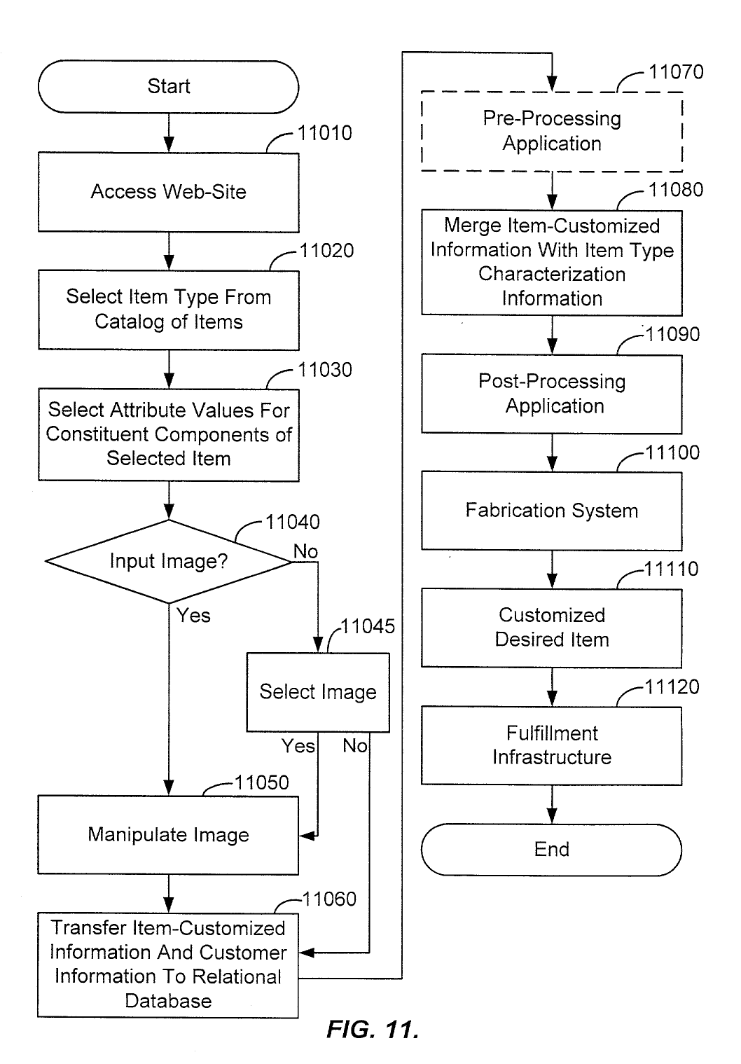

To further illustrate features of the invention, an operational process flow will be described in connection with an illustrative embodiment, as shown in FIG. 11. Initially, the web browser 1020 under control of the remote user initiates a session at step 11010 with the server application 1140 running on the server system 2100. The server system 2100 provides the web browser 1020 of the user with pages for selecting a type of item desired by the user, e.g., a 50 sheet notepad. Upon the user indicating their type of desired item at step 11020, the server system 2100 determines the constituent components 8300 for items of that type. In the case of the 50 sheet notepad, these could be, for instance, the background image, the foreground image, and the caption text. The constituent components 8300 may have attributes 8400 with values 8500 for personalization, e.g., a font face for the caption text, a size and location of the foreground image, etc. The server system 2100 provides pages to the web browser 1020 of the user to gather item-customizing information regarding the constituent components 8300 and the values 8500 of the attributes 8400 which the user provides at step 11030. As part of this process, the user specifies an image for the desired item by either inputting an image at step 11040 or selecting an image at step 11045. The user may carry on image editing operations on the image at step 11050. During his or her session, the user may place orders for a number of desired items and specify shipping in arbitrary quantities to a plurality of shipping destinations for items in the order. The user may also use a previously-edited image on a different desired item by just selecting the appropriate user prompt. In this way, the user can avoid having to repeat the editing operations previously performed. The item-customizing information (as well as shipping and other information for completing the user's order) is stored in the object model until the transaction is completed, whereupon it is transferred at step 11060 to the relational database 1200 for storage. Next, the customizing application 1300 generates a characterization of the customized desired item 1500 from the item characterization 1330 for the item type of the desired item and the item-customizing information from the user at step 11080. The pre-processing application 1220 may translate or transform data taken as input by the customizing application 1300 at step 11070. Similarly, the post-processing application 1250 may translate or transform data output by the customized application 1300 at step 11090. The fabrication system 1400 receives the characterization of the customized desired item 1500 (possibly post-processed) and fabricates the customized desired item 1500 at step 11100. Continuing the example above of the notepad, a digital printer prints the sheets of the notepad which are then assembled into the notepad. The completed customized desired item(s) 1500 are shipped through conventional fulfillment infrastructure 1600 at step 11120 in the user-specified quantities to the user-specified destinations.

As described above, item customizing information is generally provided from a remote user interacting with an interface provided to the client computer system 2200 by the server system 2100. In other embodiments of the invention, the server system 2100 could receive item customizing information from other sources. In particular, it is contemplated that other interfaces providing for electronic data exchange in large volumes could be used. For instance, it is contemplated that batches of item customizing information could be provided to the server system 2100. It is contemplated that item customizing information could be represented in the Extensible Markup Language (“XML”) and XML documents used for providing item customizing information. Embodiments of the invention receiving item customizing information in large volumes are particularly suitable for creating commercial quantities of individually customized items. In one contemplated example, a retail store or franchise represents its customer list in an XML-compliant document (or documents) along with item customizing information for each customer. One skilled in the art having the benefit of this disclosure will readily apprehend other situations where batches of item customizing information could be beneficially employed; these situations, too, are within the scope and spirit of the above-described embodiment.

Although the present invention has been described in terms of features and illustrative embodiments, one skilled in the art will understand that various modifications and alterations may be made without departing from the scope of the invention. Accordingly, the scope of the invention is not to be limited to the particular embodiments discussed herein, but should be defined only by the allowed claims and equivalents thereof.

What is claimed is:

1. A computer-controlled method of generating an imprinted item customized by a user, comprising:
receiving a specification of an item type, wherein associated with said item type are a plurality of constituent components, said plurality of constituent components comprising an image to be specified by said user;
generating a customized item characterization responsive to a predetermined characterization of said item type and further responsive to a set of values for said plurality of constituent components, wherein said customized item characterization is suitable for use by a fabrication system; and
fabricating said imprinted item customized by said user in accordance with said customized item characterization by said fabrication system.

2. The method of claim 1, wherein said receiving step is carried on via client server communications across a public network.

3. The method of claim 1, wherein receiving a specification of an item type comprises: receiving said specification in one or more batches via an electronic data exchange interface.

4. The method of claim 3, wherein said specification is received in a format in accordance with the Extensible Markup Language (“XML”).

5. The method of claim 1, wherein receiving a specification of an item type further comprises:
accepting user input of values for items from a list of item types.

6. The method of claim 1, wherein receiving a specification of an item type further comprises:
determining a list of constituent components for specification based on said specified item type.

7. The method of claim 1, wherein receiving a specification of an item type further comprises:
accepting user input of values for said plurality of constituent components associated with said specified item type.

8. The method of claim 1, wherein specifying said image comprises an image editing operation carried on via client server communications across said public network.

9. The method of claim 1, further comprising receiving shipping method, destination, and billing information for multiple specified line items for multiple quantities of specified item types.

10. The method of claim 1, wherein said item type comprises a notepad.

11. The method of claim 1, wherein said item type comprises a note card.

12. The method of claim 1, wherein said item type comprises a sticker.

13. The method of claim 1, wherein said item type comprises a notebook.

14. The method of claim 1, wherein said item type comprises a book.

15. The method of claim 1, wherein generating said customized item characterization comprises a variable print operation for generating characterizations of a plurality of customized items, each customized by a distinct user.

16. The method of claim 1, wherein said predetermined characterization of said item type comprises a template unique to said item type.

17. The method of claim 1, wherein said predetermined characterization of said item type comprises a self-describing template for said item type.

18. The method of claim 1, wherein the step of generating said customized item characterization further comprises generating item characterizations for a plurality of different item orders, each of said item orders uniquely customized.

19. The method of claim 1, wherein said fabricating system comprises a digital printer.

20. A computer-controlled system for generating an imprinted item customized by a user, comprising:
a public network;
a server system, connected with the public network, for receiving information for a customized desired item from a remote user, said information for said customized desired item comprising image data, said server system further enabling said remote user to edit said image data;
a database, coupled with said server system for storing said information for said customized desired item, and further for storing requirements information for a plurality of desired items for a plurality of remote users;
a first software application for generating a characterization of said customized desired item, responsive to a characterization of said customized desired item and further responsive to said information for said customized desired item; and
an item fabrication system for creating said customized desired item.

21. The system of claim 20 wherein receiving information for a customized desired item comprises:
receiving said information in one or more batches via an electronic data exchange interface.

22. The system of claim 21 wherein said information is received in a format in accordance with the Extensible Markup Language (“XML”).

23. The system of claim 20 wherein said item is a printed item and said item fabrication system is a printer.

24. The system of claim 20 wherein generating a characterization of a customized desired item comprises:
generating characterizations of a plurality of customized desired items, each customized by a distinct user, and wherein said fabrication system concurrently fabricates each of said plurality of customized items of like type.

25. The system of claim 20 wherein enabling said remote user to edit said image data comprises enabling an image cropping function.

26. The system of claim 20 wherein said information for said customized desired item further comprises shipping information for shipping one or more instances of said customized desired item to each of a plurality of separate destinations.

27. The system of claim 26 wherein different shipping methods can be selected for each said separate destination.

28. The system of claim 26 wherein shipping rates are immediately calculated based upon a particular shipping method and a particular shipping destination.

29. The system of claim 28 wherein said shipping rates are immediately displayed to said user.

30. The system of claim 20 wherein said server system executes application logic for determining a list of attributes for specification based on a type of the desired item.

31. The system of claim 20 wherein said characterization of said desired item is a document template.

32. The system of claim 31 wherein said characterization is self-describing.
